(19) United States
(12) Patent Application Publication
(10) Pub. No.: US 2020/0044930 A1
(43) Pub. Date: Feb. 6, 2020

(54) Apparatus And Method Relating To Data Distribution System For Video And/Or Audio Data With A Software Defined Networking, Sdn, Enabled Orchestration Function

(71) Applicant: Global Invacom Ltd, Stevenage Hertfordshire (GB)

(72) Inventors: Gary Stafford, Stevenage Hertfordshire (GB); Pandelis Kourtessis, Hatfield Hertfordshire (GB); Matthew Robinson, Hatfield Hertfordshire (GB)

(21) Appl. No.: 16/339,252

(22) PCT Filed: Oct. 3, 2017
(86) PCT No.: PCT/GB2017/052963

§ 371 Date: Apr. 3, 2019

(30) Foreign Application Priority Data
Oct. 3, 2016 (GB) 1616763.7

(51) Int. Cl. H04L 12/24

(52) U.S. Cl. CPC H04L 41/0896; H04L 41/5025; H04L 41/022; H04L 41/042; H04L 41/509

(57) ABSTRACT

The invention relates to a system for aiding in the connectivity of data which is received in one but typically a plurality of manners from remote locations to user end devices which are connected to a data distribution network, at least part of which carries the data in an optical format. The combination and transfer of the data to device simultaneously is achieved through the use of a control means in the form of a software defined networking (SDN) enable orchestration function.

The invention to which this application relates is to the provision of apparatus and a method which allows for the generation and usage of networks to which a number of devices can be simultaneously connected and which network can be adapted and developed in order to allow the reconfiguration of the network in order to meet changes in the requirements of and/or growth in the capacity and/or operation of the network over time.

As communication systems and the demands on the capacity of the same continue to develop and increase, so there is a need to be able to utilise the communications systems which are already available to advantage whilst, at the same time allowing the networks which are generated to be configurable so as to be able to be used subsequently and adapted to new uses in order to avoid the need and expense of wholesale change.

For example, at present the use of the 5G communication system can be utilised but such use is required to be defined in a manner which allows the same to be compatible with various forms of network system, one such network being an optical system using fibre optic cabling and one example of that being a Time-Wavelength Division Multiplexed Passive Optical Network (TWDM-PONs). Furthermore, there is a need to be able to provide data for use with, and which can be made accessible by, the network. One such source of data for the network can be a Digital Broadcasting Systems (DBS) in which the data can be provided via, typically, a terrestrial, satellite and/or cable broadcast transmission system.

As an example of the increase in demand, in 2015 global mobile data traffic grew by 74%; from 2.1 exabytes per month at the end of 2014 to 3.7 exabytes per month at the end of 2015 and it is forecast that by 2020 traffic will exceed 30.6 exabytes per month, and that by that time there will be 1.5 mobile devices per capita, totaling 11.6 billion mobile connected devices globally. Furthermore the type of content being delivered is expected to continue to change primarily to video centric services and 75% of content is expected to be high bandwidth video by 2020, which is an 11× increase in video bandwidth in comparison to that of 2015. In addition, in 2015, 51% of the total mobile data traffic was offloaded onto fixed networks either through WiFi or femtocell technology which accounts for an additional 3.9 exabytes per month.

The quality of experience (QoE) expected and deemed acceptable by users is also increasing to levels that are, or will soon be unachievable using current technology. A rapid growth of interactive higher bit rate video content services and the predicted increase in machine to machine (M2M) type communication have resulted in the need for 1 ms latency, as well as 10 Gbps throughput targets for 5G communication systems.

The increase in M2M communications will also result in a significant increase in traffic in the future. For example, in 2015, 604 million M2M communications were made and this is set to increase to 3.1 billion by 2020. The provision of devices which can be worn with either embedded cellular technology or connections to the network using partner devices, by for example, Bluetooth, are forecast to account for a large percentage of this increase. In order for these new demands to be met by the access network operators, a shift in infrastructure formation needs to be undertaken and the next generation of mobile communications, 5G, is currently being designed to fulfil these service requirements based on the new set of targets. The target latency has been set at 1 milliseconds end to end delay and the target throughput has been set at 10 GBPS. These targets fulfil the requirements of M2M communications and also fulfil the requirements of video streaming at ever increasing resolutions and immersive techniques such as virtual reality, 3D video and ultrahigh frame rates.

It is an aim of the present invention to provide a system which allows for the combination of the data source system, the network format and the ever increasing demand for data capacity and device access.

In a first aspect of the invention there is provided a system for the provision of data to a number of devices simultaneously, said system including at least one data source from which data broadcast from a remote location is accessible, a data distribution network to which data from the data source is transferred and made available to a plurality of devices connected to the said data distribution network, and wherein the system includes a control means in the form of a Software Defined Networking (SDN) enabled orchestration function.

Typically the data is transferred in the network at least for a portion of the same in an optical format to thereby maximise the available bandwidth in the network.

In one embodiment the distribution network includes fibre optic cabling and in one embodiment laser transmitters and/or receivers are provided at those interfaces between the data distribution network fibre optic cabling and hardware apparatus which require the data to be provided in an alternative format for processing and/or onward transmission and/or which have received the data in another format.

In one embodiment the other format is RF format.

Typically the orchestration function is provided so as to allow the system to be able to be adapted to absorb changes, typically increases, in demand for device activity and/or data provision.

Typically the orchestration function allows the quality of the service provision to be maintained whilst increasing device access capacity and/or data provision capacity and allows the network to be provided with the combination of reconfigurability, the meeting of latency requirements, adaptive network functionality, and achieve the Quality of Experience (QoE) to be met and which requirements are due to the continuous growth of the internet, the rapid increase of “smart” data processing devices and attempts to consolidate Mobile Fronthauling (MFH) with emerging IP based video streaming applications.

In one embodiment the orchestration function allows the provision of any, or any combination, of network function decentralisation, support for MFH using CPRI and CPRI over Ethernet (CPRIoE) services, OLT-side intelligent caching using local NFV, QoE assurance via CDN ISP collaboration, and local video streaming replacement services by using OLT-side SatIP servers are presented.

Typically the orchestration function is centralised with respect to the system and is controlled and adapted by the system administration so as to control the infrastructure in detail, typically substantially continuously using custom built or off the shelf applications.

Typically the use of standardized application programming interfaces that control the network hardware means that custom network controllers for specific scenarios can be prototyped and implemented and updated as they run in at the centralised location.

In one embodiment there is provided a combination of optical and mobile fronthauling (MFH) technologies.

In one embodiment IP digital broadcast systems such as DBS and SatIP are incorporated into the system. In one embodiment the integration of SatIP is performed in mobile base stations and this achieves a reduction in backhaul network congestion as users can stream multimedia live feeds directly from SatIP servers rather than using internet services provided by the network.

In one embodiment connectivity to all cellular, femtocell and WiFi communication technologies is achieved using TWDM-PON hauling. In one embodiment this is achieved close to intelligent access nodes of the premises at which the network is provided and via the orchestration function so as to enable existing technologies to work together and provide an intelligent control system for each technology maintain command.

In a further aspect of the invention there is provided apparatus for the distribution of video and/or audio data, said apparatus including a data receiving apparatus including at least one satellite antenna and LNB vi which data is received from one or more remote locations, a plurality of user devices which are capable of receiving a portion of said data and processing the same to generate video and/or audio on a display screen and/or speakers provided on or in connection with said devices, a data distribution network to which the user devices can be selectively connected and wherein the apparatus further includes a Software Defined Networking (SDN) enabled orchestration function to allow adaptation of the operation of the performance of the network to be controlled with respect to user device demands, data capacity demands and/or control of the whole or slices or sectors of the network to be achieved.

In a further aspect of the invention there is provided a method for the provision of data for video and/or audio to a number of devices simultaneously, said system including at least one data source from which data broadcast from a remote location is accessible, a data distribution network to which data from the data source is transferred and made available to a plurality of devices connected to the said data distribution network, said network and wherein the network is connected to a control means in the form of a Software Defined Networking (SDN) enabled orchestration function and adapting said network via said orchestration function with respect to the capacity for data transfer, number of devices connected to the said network and/or the control of the network as a whole or in slices or sectors independently.

Specific embodiments of the invention are now described with reference to the accompanying diagrams wherein:

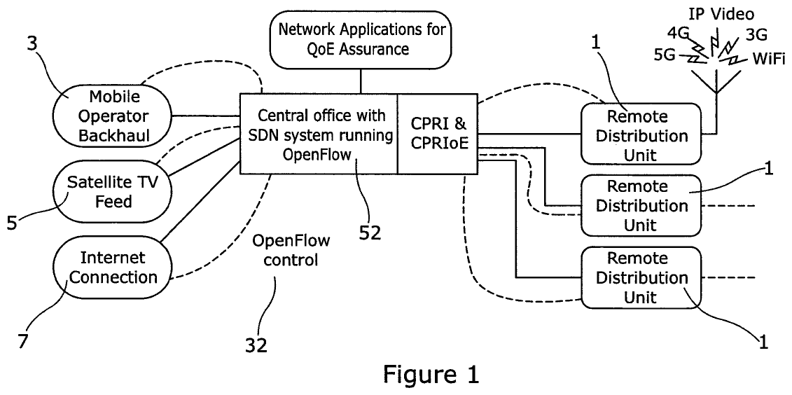

FIG. 1 illustrates a software defined networking block diagram;

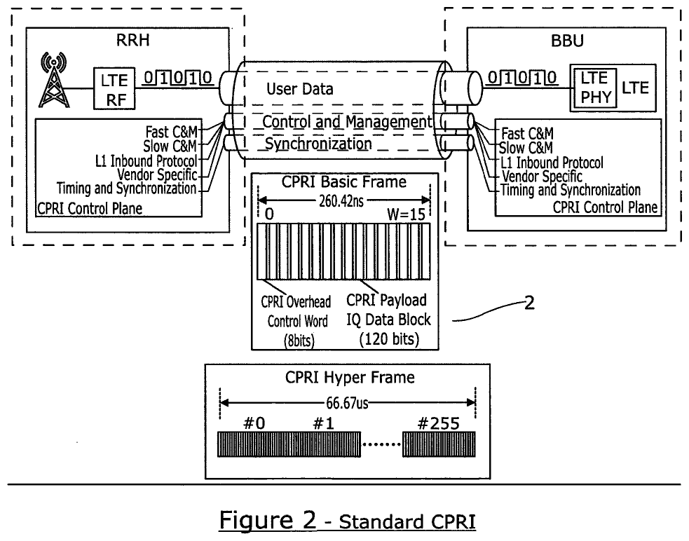

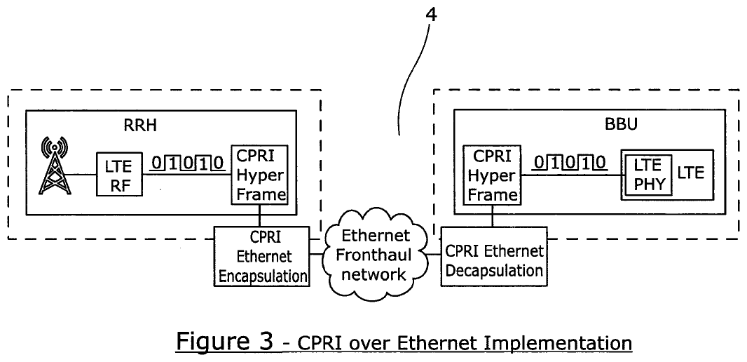

FIG. 2 shows a standard CPRI system;

FIG. 3 shows CPRI over Ethernet Implementation;

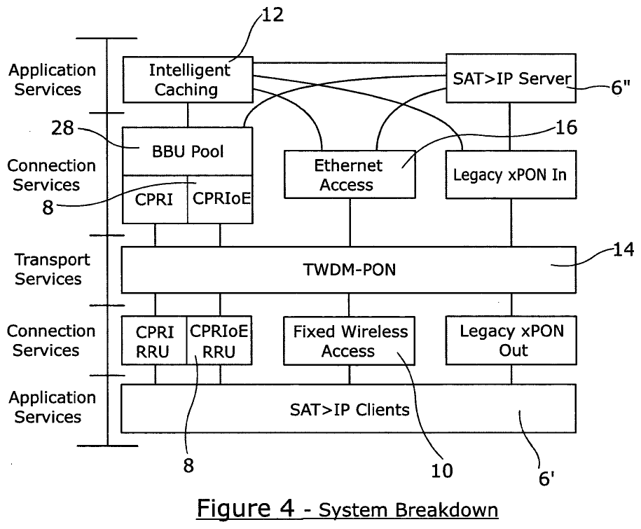

FIG. 4 illustrates a system in accordance with the invention schematically;

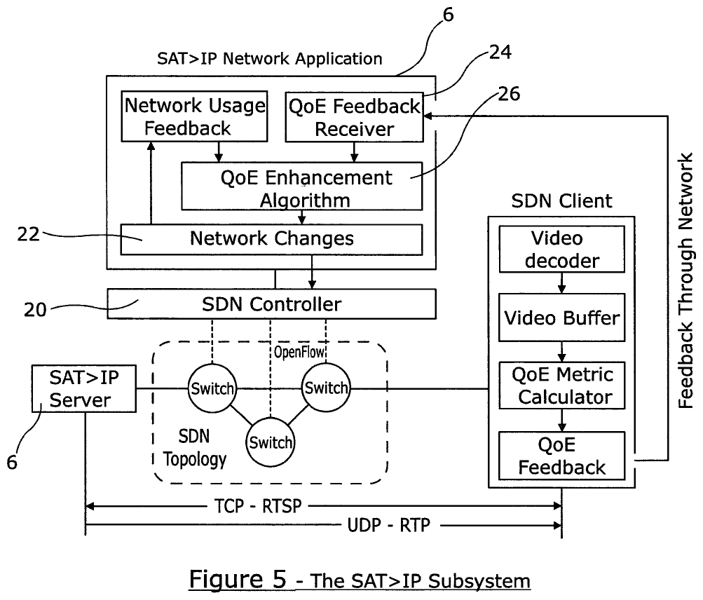

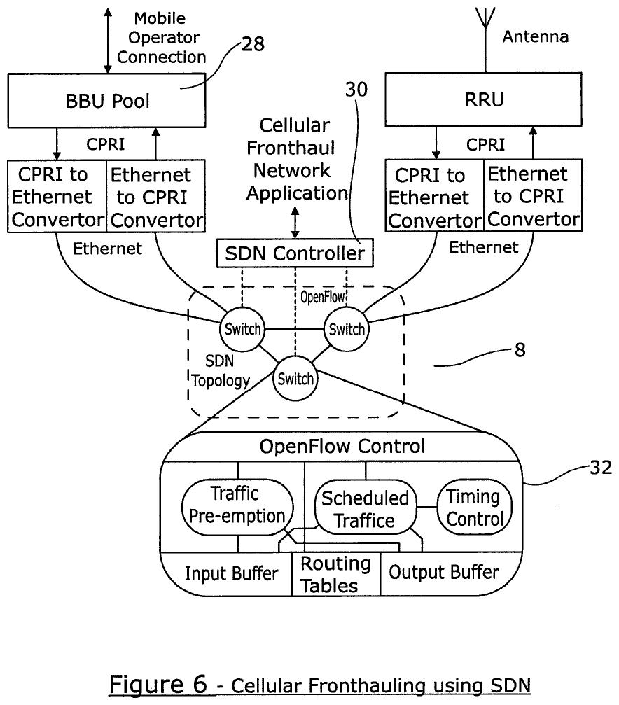

FIG. 5 illustrates an embodiment of the SAT>IP subsystem in accordance with the invention;

FIG. 6 illustrates an embodiment of a Cellular Fronthauling subsystem using SDN;

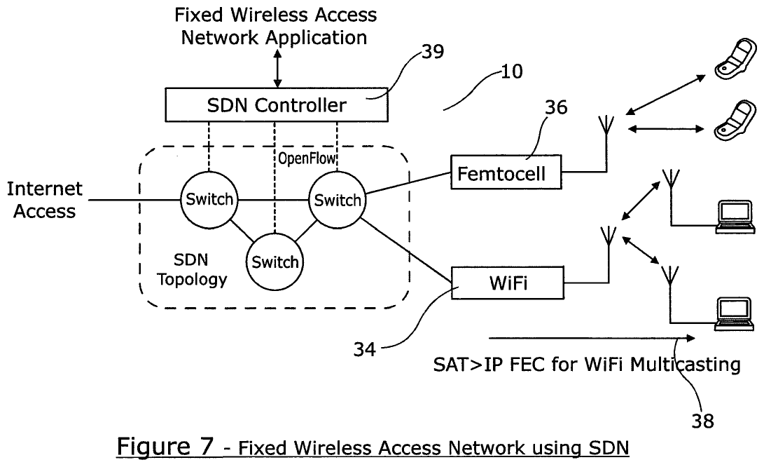

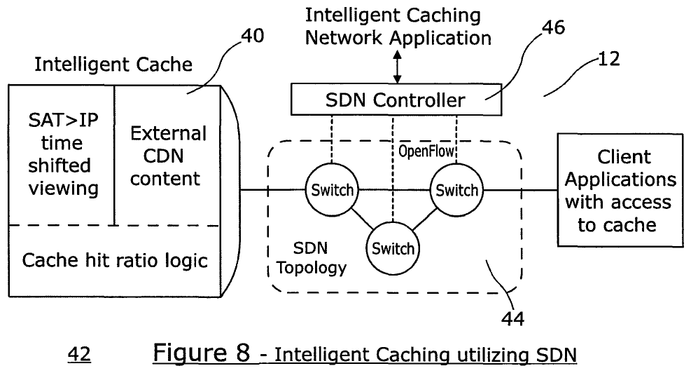

FIG. 7 illustrates a fixed wireless access network subsystem in accordance with one embodiment using SDN;

FIG. 8 illustrates an embodiment of an Intelligent Caching subsystem utilizing SDN in accordance with the invention;

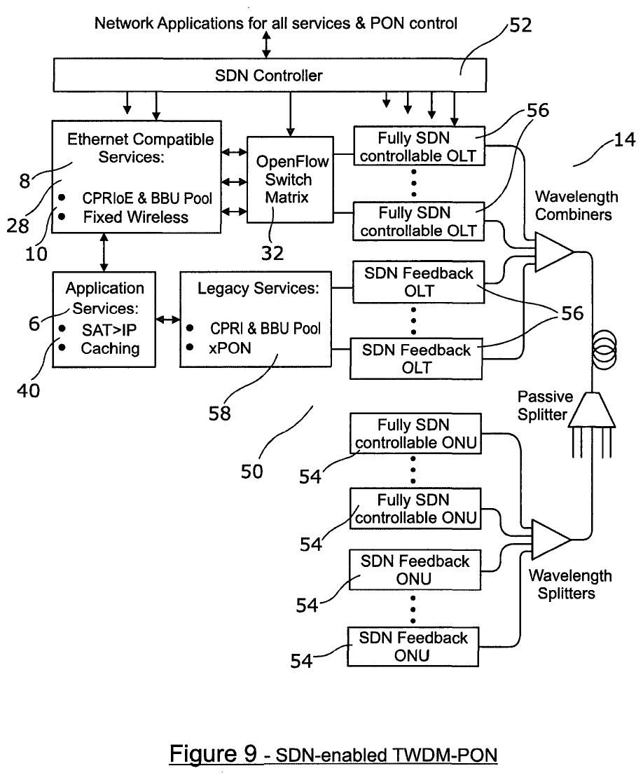

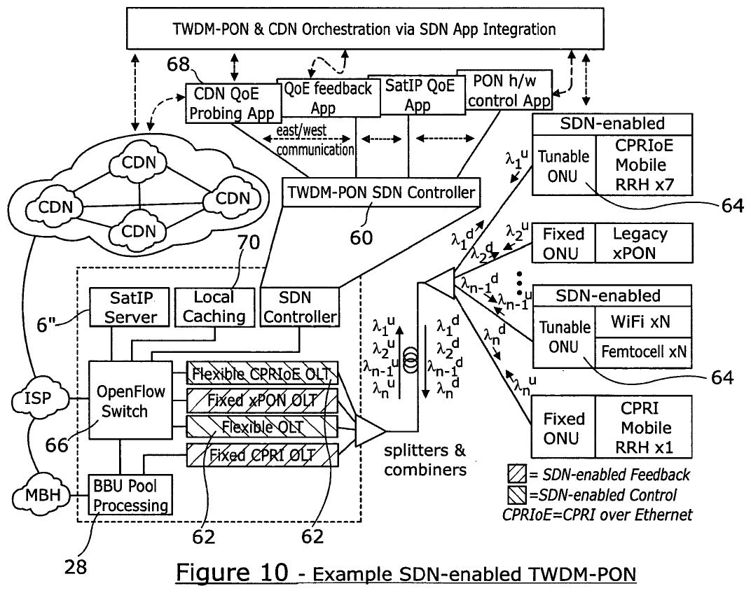

FIG. 9 illustrates a system showing the manner in which legacy services can be supported on the SDN-enabled TWDM PON using OpenFlow feedback;

FIG. 10 shows an embodiment configuration of the system of FIG. 9;

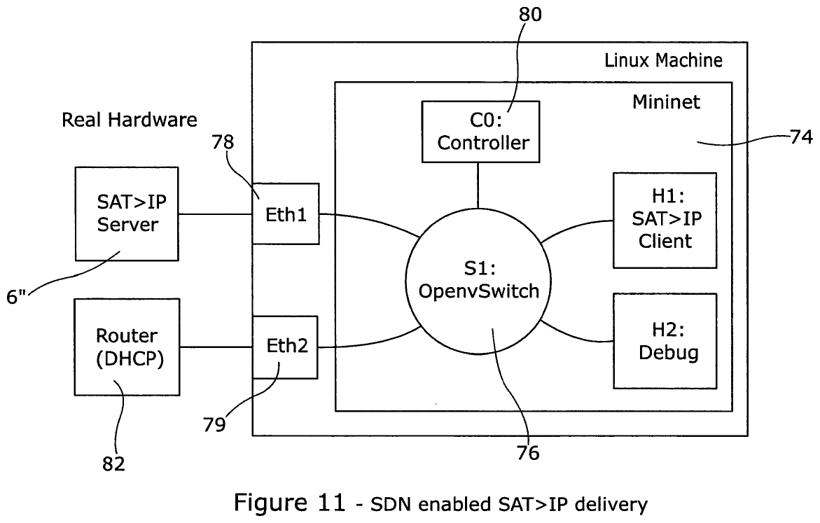

FIG. 11 illustrates an emulation of an SDN-enabled SAT>IP delivery subsystem;

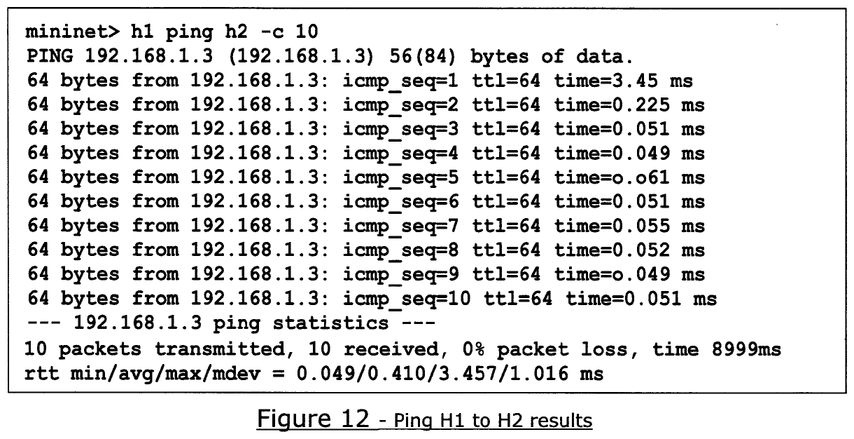

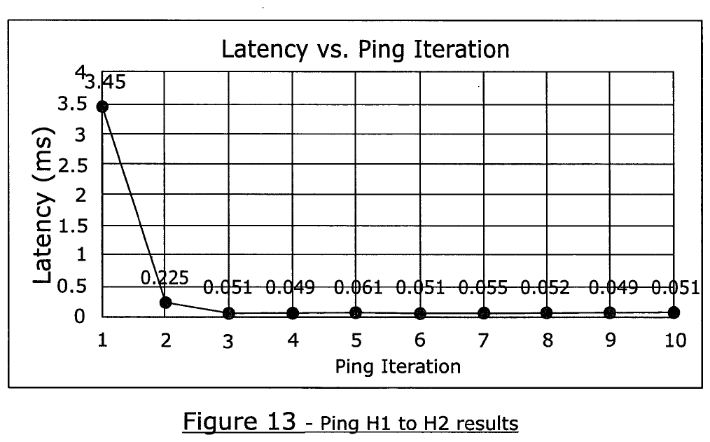

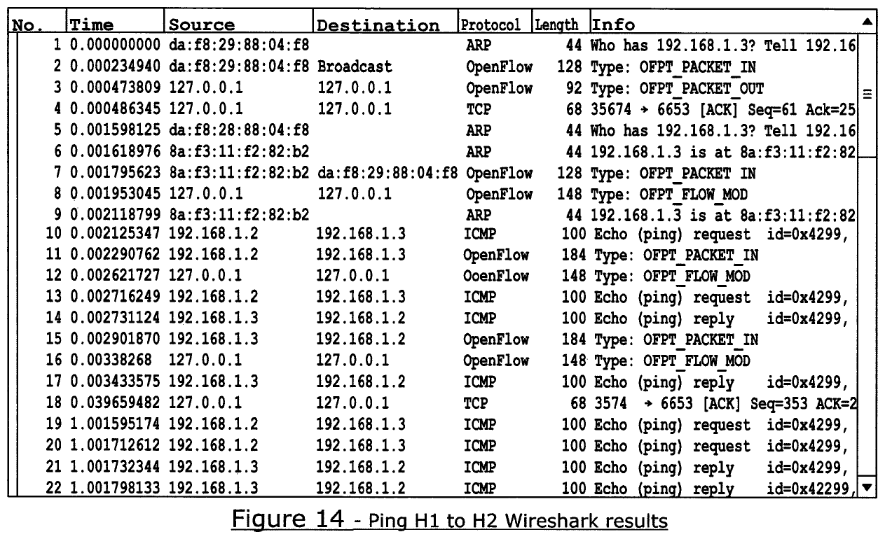

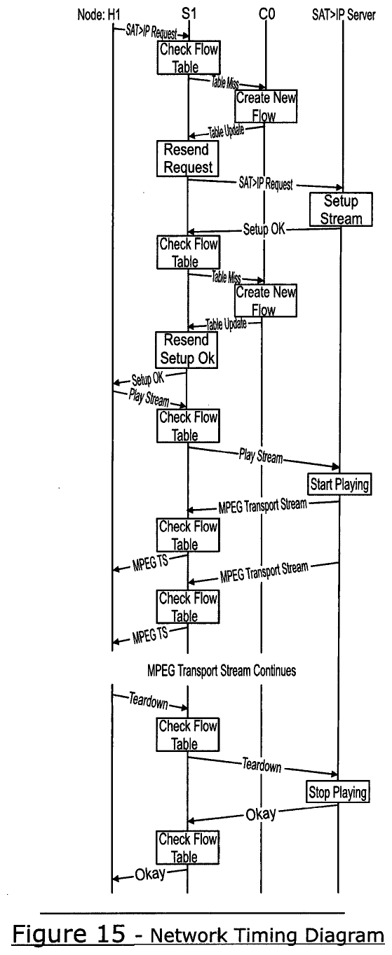

FIGS. 12-15 illustrate the terminal output for the Ping command, a graphical display of these Pings can be seen in FIG. 13 and the most important captured packets can be seen in FIG. 14 and illustrated in the network timing diagram of FIG. 15;

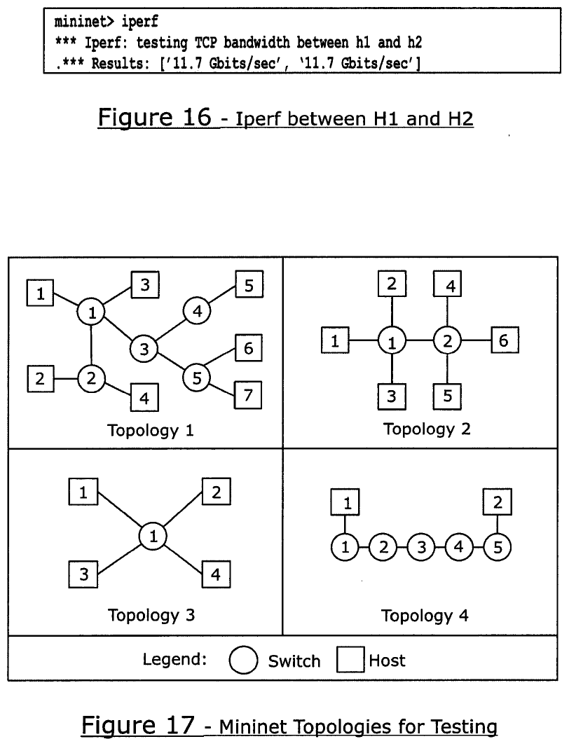

FIG. 16 illustrates the Iperf between H1 and H2;

FIG. 17 illustrates the Mininet Topologies for Testing

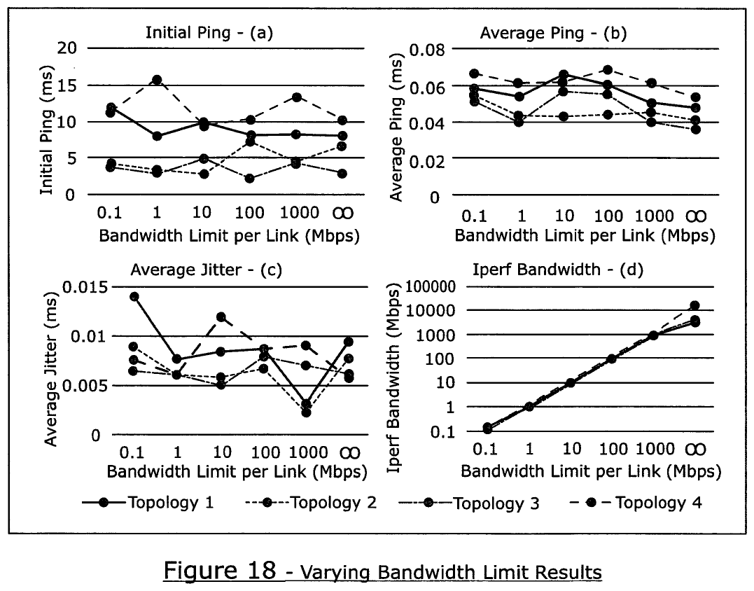

FIG. 18 illustrates Varying Bandwidth Limit Results;

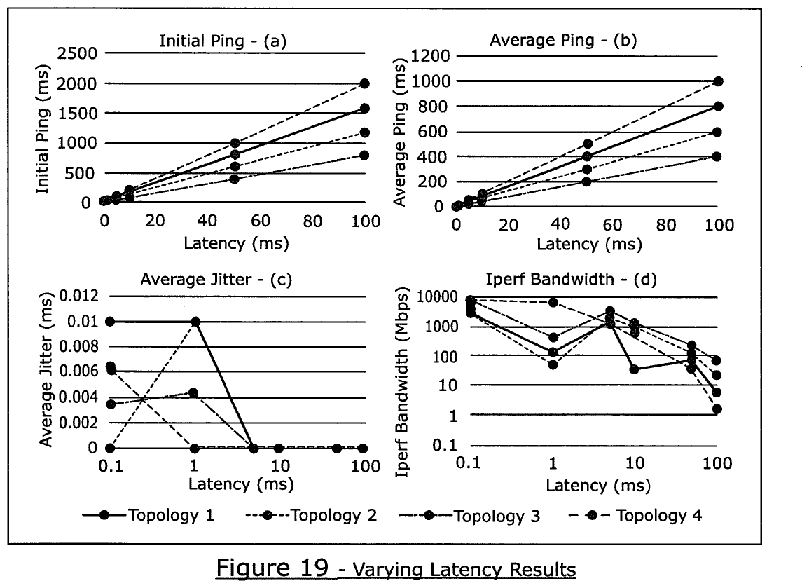

FIG. 19 illustrates Varying Latency Results;

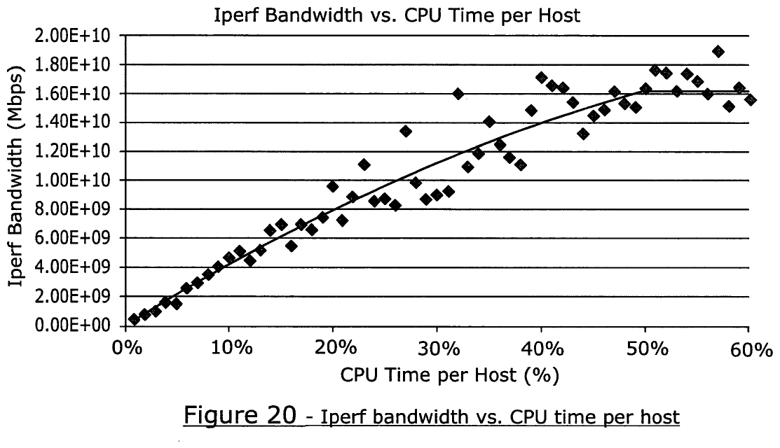

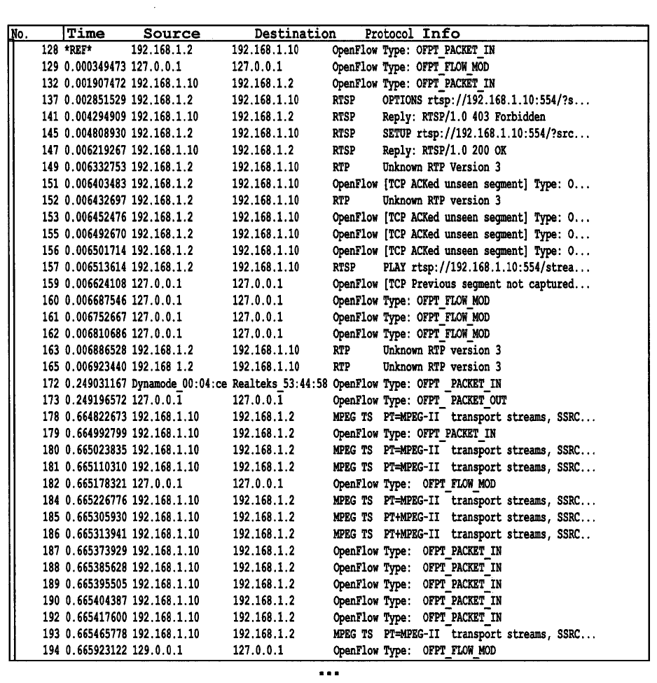

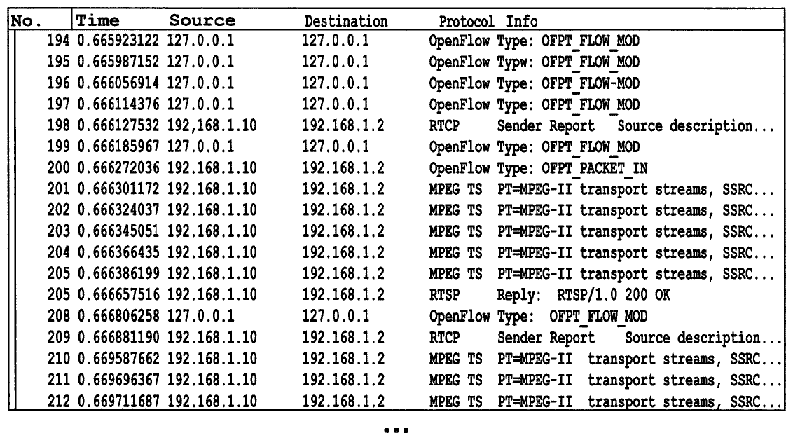

FIG. 20 illustrates Iperf bandwidth vs. CPU time per host

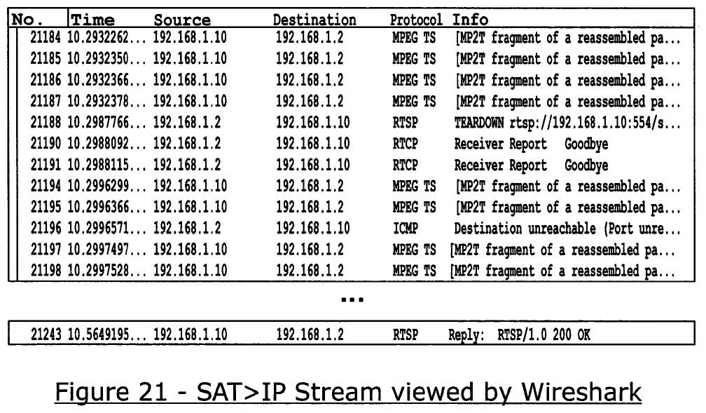

FIG. 21 illustrates the SAT>IP Stream viewed by Wireshark;

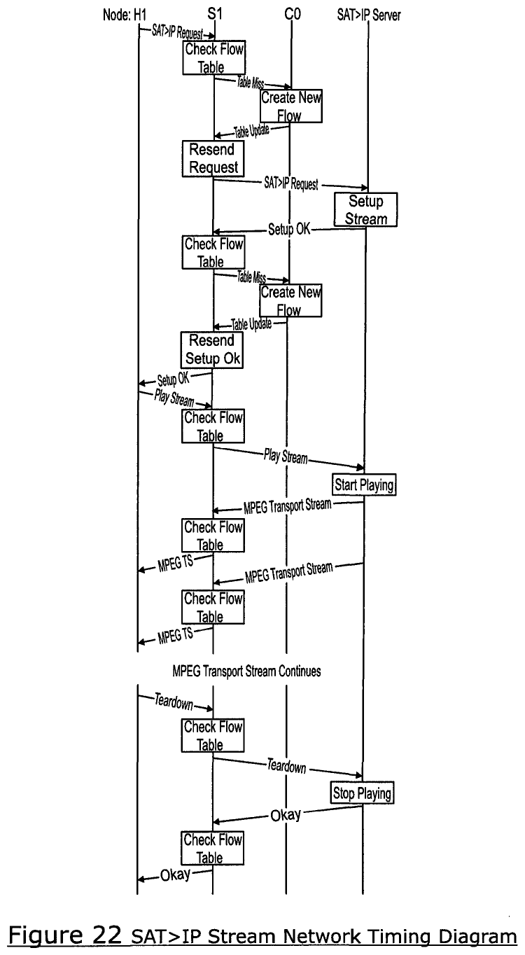

FIG. 22 illustrates the SAT>IP Stream Network Timing Diagram;

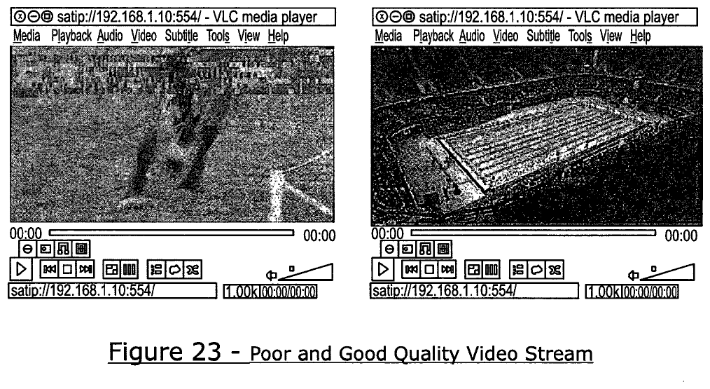

FIG. 23 illustrates the images created from Poor and Good Quality Video Streams; and

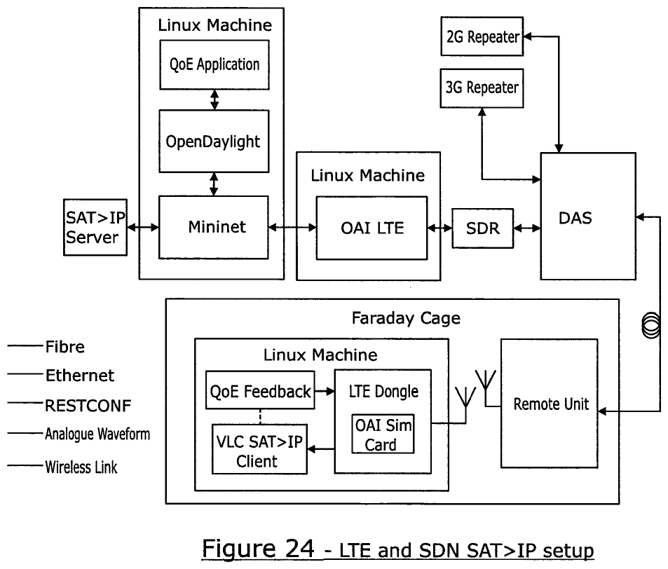

FIG. 24 illustrates an embodiment of an LTE and SDN SAT>IP setup

With reference to FIG. 1 there is provided an example of the provision of a data communication network to which a number of devices can be simultaneously connected via distribution units 1 at different locations and each of which has one or more data communication means. The network shown incorporates an SDN orchestration function 52 and open flow switch network 32 in accordance with the invention and includes data sources in the form of Mobile operator backhaul sources 3, satellite television data 5 and an Internet or broadband connection 7.

The system illustrated shows the manner by which the latest PON standards can be facilitated thereby providing means by which the wavelength flexibility for fibre to the x (FTTx) can be facilitated.

In one embodiment, when centralised radio access network (CRAN) mobile fronthauling is considered, either a wavelength can be dedicated to a common public radio interface (CPRI) connection, or CPRI over Ethernet (CPRIoE) can be used in an Ethernet data plane network. When using CPRIoE, OpenFlow control messages can use the same Ethernet links to control the data plane. Typically CPRIoE is implemented over a TDM-PON utilising IQ data compression and it is experimentally confirmed that, with compression, the relatively stringent delay jitter demands of CPRI (±8.138 ns) as specified can be met. In experimental results the maximum delay jitter was found to be +1.225 ns. It is proven numerically that 7 optical network units (ONUs) at CPRI rate option 3 can be supported if the latency requirements of the system are 100 μs or higher excluding any propagation time.

The application of the SDN orchestration function and the SDN enabled PONs exhibiting on-demand spectrum allocation and flexible grid can be demonstrated experimentally using 150 Mbps-per-cell orthogonal frequency-division multiple access mobile backhaul (MBH) overlays. Similarly, a flexible 40 Gbps TWDM-PON architecture allows 4×10 Gbps OFDM downstream traffic to be achieved utilizing SDN enabled optical line terminals (OLTs).

SDN control from a logically central location orchestration function allows the intelligent adaptation of the access network to user demand to be achieved by prioritising latency and/or dynamically allocating bandwidth to mobile connections and FTTx.

FIG. 1 also shows how DBS's such as Sat-IP support can be incorporated into the access system utilising the SDN enabled access.

Within DBS's, the most notable advance in technology is SatIP which can be used to replace legacy broadcast data receivers (set top boxes) and satellite dishes at each premises or location of use and instead use an IP infrastructure that allows multiple users to connect to a data feed of data which has been received at a single satellite dish and LNB using smart devices. Additionally, users that are unable to install regular satellite dishes at their homes, for example, multiple dwelling units, can use an IP network installed within their building to receive satellite services. Furthermore, because SatIP uses Ethernet connection, the SDN orchestration function in accordance with the invention can, in one embodiment, be used to control the operation of the Sat IP and QoE assurance.

Furthermore, in accordance with the invention the use of SatIP services can remove traffic from the MBH and internet service provider (ISP) networks by reducing the live video content which is required to be streamed from CDNs which are made up of many ‘local’ caches that can scalably dedicate computing resources to video services according to demand, and supply content from the most appropriate nodes. They have been primarily used because they can provide higher QoE compared to video streamed from standard servers and the provision in accordance with the invention of the SDN enabled CDN and ISP collaboration can enable a higher QoE for video streaming clients whilst reducing the demand on the network data transfer.

ISP and CDN collaboration allows the CDN to integrate applications into the SDN network infrastructure so that CDN can access key information about the ISPs network such as topology and load. This approach significantly decreases the number of stalls or pauses in the playback of video on users devices connected to the network, particularly in “flash crowd” scenarios when compared with conventional DNS based redirection systems. The collaboration between content provider, network service provider, and equipment manufacturer was achieved by running applications within the SDN control system and the QoE for the video consumers via their devices was increased using a feedback process that measured the buffering status and video player state and then dynamically changed the video quality and route to the client via SDN control. By simulation, a 55.9% improvement was seen during congested network times.

Similarly, a dynamic adaptive streaming mechanism is employed to determine the users QoE by ascertaining the end user's video buffer status. This information is then used to choose between buffered or real time video streaming modes. Additionally, a bandwidth allocation scheme is used in an SDN enabled optical fibre connection to the home network that increases the QoE to video users by allocating resources based on the user's “sweet point bandwidth”. The “sweet point bandwidth” is a bandwidth where, once achieved, no real gains in QoE are experienced even when more bandwidth is allocated to the services.

With regard to video data, there are two main areas to which the invention of this application is of relevance, live video and on demand video. An example of live video are DVB broadcast services such as DVB-T2 BBC1, whereas on demand services are those which are available for the streaming of data representing television or radio programmes to user devices at any time i.e. there is no set broadcast time and the streaming is performed as a result of a user request. In order to ease the access network of the demands of live video delivery, live video offloading is used to move the video load onto another source. Thus, instead of streaming the live video from the internet via the backhaul network, the video data can be sourced closer to the user, in the access network of the current invention, by capturing the live video from another feed. For example, satellite, cable or terrestrial services. This captured live video can then be sent to the user as a replacement service, reducing the load on the backhaul network, reducing the latency experienced by the user, and providing a higher quality video than is typically available via internet streaming services.

An example of an on demand video service is that provided vi the BBC I-player where pre-recorded programmes can be streamed by the user from content distribution networks at any time of day at their convenience. To ease the access network of the on demand video playback requests when they are made, intelligent caching is used within the access network to reduce the bandwidth needed on the backhaul link. However, this requires a caching infrastructure to be installed within the access network so that the same can intelligently cache content most likely to be supplied to users based on the most likely requested content. Intelligent caching can, in turn, be improved by allowing CDN and internet service provider (ISP) cross platform cooperation. The large difference in characteristics between M2M and video service is taken into account and the impact reduced by splitting the network into different virtual networks which are designed for different services. For example, video and M2M communications can run in different splits tailored towards either high data rates or low latencies and these splits can also be used to create separate networks for different network operators using the same hardware.

The features described above can be achieved when using an SDN controlled access network in accordance with the invention as live and on demand video feeds are automatically rerouted to alternative local locations within the access network by using intelligent network controllers. CDNs and ISPs collaborate by using SDN controllers to provide instant network re-configurability based on the detected, current network demands and the topology constraints. Network splitting is achieved by using network slicing in the SDN network and this allows a plurality of individual network controllers to be operating simultaneously and operating with respect to their own virtual subset or, alternatively a real physical network.

In one embodiment each slice or sector is managed by respective allocated network operators and the operation is performed independently of each other within network operating parameters. This allows each of the operators to selectively adapt their operation and control of their slice or sector of network operations in order to provide different and optimised services.

In one embodiment the adaptation can be to introduce low latency or high bandwidth features to the operation of their particular slice or sector.

In accordance with the invention, a video replacement service as described is provided using SatIP and cached video services, which are controlled via an SDN controllable physical layer and a heterogeneous SDN enabled access structure that allows cellular, legacy PON, and fixed wireless networks to run in isolation at the same time whilst they all use their own network controllers with the use of network slicing.

The SDN based Sat IP delivery access network includes the development of network controller applications that adapt the network to let the user achieve the optimum quality of experience (QoE) based on live feedback from the user of the video data to the network application.

As part of the system CPRI over Ethernet (CPRIoE) mobile fronthauling is used. This is the concept of packetizing CPRI data into Ethernet frames for transportation over an Ethernet network. An example of CPRI and its integration to CPRIoE is shown in FIG. 2 which shows a CPRI system 2 and FIG. 3 which shows a CPRIoE system 4 in accordance with the invention.

The system in accordance with the invention is based on components that are fully SDN controlled and are modularised so they can work, both independently of each other and with each other, with minimal change or adaptation. An example of such a system is shown in FIG. 4 where it is shown that the system is broken into subsystems comprising including a SatIP subsystem components 6, CPRIoE subsystem components 8, fixed wireless network subsystem 10, an intelligent caching subsystem 12, and a TWDM-PON subsystem 14 for transportation. The modularisation means that each service subsystem can run, within its own virtual network, to provide benefits. In this description, SAT IP 6, CPRIoE 8 and fixed wireless network access 10 subsystems, are regarded as services and the TWDM-PON subsystem 14 is regarded as the means of transportation for the services.

In the first subsystem 6 as shown in FIG. 4, satellite TV is distributed to consumers by using SatIP in an Ethernet access network 16 utilising SDN controllable switches, an intelligent controller, and accompanying tailored network applications. As shown in FIG. 4 to enable intelligent network changes 22 to be made by the network applications, information from each user device is fed back regularly to the QoE Feedback receiver 24 using the custom made SatIP clients 6′.

The SatIP client subsystem 6 allows the user to view SatIP content served from a SatIP server 6″ on the same network. The application uses real time protocol (RTP) to receive real time video and audio data from the SatIP server 6″ in user datagram protocol UDP frames, and uses the real time streaming protocol RTSP control protocol to set up, close down and configure connections with the server 6″. Thus the SatIP video client is able to calculate QoE metrics 26 based on the decoded video feedback that is then sent to the SDN controller 20. The SDN controller 20 and SatIP network application 6 can then use these QoE metrics 26 from each user device to make positive changes 22 to the network based on the current network configuration and demand. FIG. 5 illustrates a structure of an embodiment of the SAT IP subsystem using an SDN.

In the second subsystem illustrated in FIG. 6 5G mobile operator data is fronthauled using CPRIoE in an Ethernet access network utilising SDN controllable switches and an intelligent controller. The system is designed to be most intelligent in a CRAN topology, where a BBU pool 28 processes multiple mobile fronthaul connections simultaneously. Mobile fronthaul information including link latency and jitter can then be made available to the access network's SDN controller 30 and mobile access network's network applications so intelligent network changes can be made. In addition to this, the new IEEE 802.1Qbu and IEEE 802.1Qbv proposed enhancements can be incorporated into the current SDN switches and so centralised changes to scheduled traffic and traffic preemption strategies and algorithms can be made using an evolution of the Open Flow control protocol 32 in the SDN Controller topology.

This subsystem 8 is also designed to be capable of using CPRI without Ethernet conversion for transport, thereby allowing legacy support for CPRI systems. This is achieved by running CPRI and CPRIoE on different wavelengths within a TWDM-PON as illustrated in FIG. 6.

In the third subsystem 10 shown in FIG. 7, a fixed wireless access network is introduced to provide support for WiFi 34 and femtocells 36. The WiFi and femtocells are provided with an Ethernet connection and as they don't require a centralised control or administration, unlike cellular networks, an Ethernet based TWDM-PON can be run natively. The fixed wireless access network subsystem 10 runs within its own network slice or sector using SDN controller 49 in the SDN network and can also use new techniques to broadcast SatIP 38 to multiple users with the introduction of WiFi packet forward error correction (FEC)).

In the fourth subsystem 12 illustrated in FIG. 8, intelligent caching 40 is made available on the centralised side 42 of the distribution network. The intelligent caches are based on the node of a CDN, where the most used content is stored locally in the access network for quick access by the user devices. The intelligent cache is connected directly to the access network centralised SDN switches 44 thereby enabling the BBU pool 28, fixed wireless access network 10 and SatIP server 6″ to access the intelligent cache 40. This means that the mobile and WiFi/femtocell operators can have access to the cache, and the SatIP server 6″ can offer time-shifted viewing to the user. The intelligent cache 40 also uses SDN network applications running on the controller 46 to best allocate bandwidth and priority to the services on the network.

The last subsystem 14 in this embodiment, is a TWDM-PON transportation plane that brings together all of the previous subsystems into a cohesive heterogeneous access network 50. SDN technology and orchestration function layer 52 is used to produce an intelligently governed network that is capable of supporting network slices for different techniques, applications and vendors. The TWDM-PON uses intelligently governed tuneable ONU's 54 and OLT's 56 so the wavelength being used in the PON can be selected by the network controller 52. The TWDM-PON can also support legacy systems 58 that cannot support variable or dynamic wavelength allocations such as native CPRI or support for legacy xPONS. These legacy services can run on their own dedicated wavelengths using their standard fixed ONU's and OLT's. The intelligent controller 52 is informed by the SDN compliant central side OLT using an extension to Open Flow 32 for feedback but not control. This allows the legacy services 58 to work in their native ways, meaning the existing equipment can be passed through the new PON without any comprises. FIG. 9 illustrates how legacy services can be supported on the SDN-enabled TWDM PON using OpenFlow feedback 32.

FIG. 10 shows an example configuration and there is illustrated an SDN configurable TWDM-PON 60 which forms an architectural foundation. Wavelengths can be selected intelligently by the OLT-side SDN controller 60 via means of tuneable OLTs 62 and ONUs 64. The TWDM-PON supports legacy xPON standards by setting fixed wavelengths for upstream (US) and downstream (DS) communication. MFH can be set up with either CPRI, provisioned on its own fixed wavelengths for US and DS communication; or with CPRIoE, in which case the wavelengths used are determined by the OLT-side SDN controller. Additionally, SDN controlled flexible access services such as WiFi and femtocells can be provisioned dynamically on the TWDM-PON.

On the OLT-side, the CPRIoE, xPON, and flexible access services are connected directly to an OpenFlow switch 66. The OpenFlow switch has connections to a local SatIP server 6″, local intelligent caching server, and to the access network SDN controller 60 itself, as well as connections to the ISPs delivery network and the BBU processing pool 28 for the mobile CRAN. MFH via CPRI is connected to the BBU pool 28 directly after optical/electrical conversion, and CPRIoE traffic is forwarded to the BBU pool by the OpenFlow switch as directed by the SDN controller 60. Full integration of the BBU Pool 28 to the SDN stack provides additional control over the MFH, allowing SDN enabled next generation coordinated multipoint (CoMP) technology, and is a possible area for future research to be aimed towards.

The OLTs and ONUs for CPRIoE and flexible services are fully SDN controlled due to the native Ethernet protocol used on the link. The SDN controller 60 can directly set the wavelengths used for these services within the TWDM-PON. This allows dynamic wavelength control for both US and DS communication. The OLT-side laser controller for the optical transmission of data through the network is directly connected to the OpenFlow Switch 66 and uses proprietary OpenFlow messages for SDN application based control. The ONU side is likewise controlled by vendor specific OpenFlow packets that communicate with OpenFlow controllable lasers and receivers via the Ethernet based PON link. These OpenFlow control packets are sent through the link with the CPRIoE or flexible service Ethernet data, and are extracted and acted upon by the OLT controller.

The OLTs 62 for the legacy xPON and native CPRI services are partially SDN enabled so they can feedback information to the SDN controller about the US and DS wavelengths used by the legacy xPON and CPRI connections. This is so the SDN controller 60 can position other services around them. The rest of the xPON and CPRI setup is left untouched so the native xPON and CPRI protocols can work unhindered. OLT and ONU controllers that natively support SDN are necessary for future access networks, and require further research and development.

Applications running on top of the SDN controller allow the TWDM-PON, SatIP server, BBU Pool, Flexible OLTs 62, and Flexible ONUs 64 to be intelligently controlled. All of the TWDM-PON OLTs and the SDN enabled ONUs feedback information to a TWDM-PON hardware control application running on the northbound side of the SDN controller 60. The application then selects wavelengths based on the physical characteristics of the channel and the capability of the hardware in the system for each service, and updates the TV/DM-PON hardware.

QoE information for video services is collected from users by a separate application. The information collected can then be shared with the other northbound applications using the east/west application programming interface. One such application is the CDN probing application 68 that allows critical QoE information to be disclosed to the CDN network, so the QoE of its clients can be enhanced by sweet point bandwidth allocation schemes. By using separate applications for QoE feedback and communication with the CDN, the need for direct communication with the client about ISP topology is removed. This means the ISP can control how much information about their network they disclose to the CDN. The QoE information can also be shared with other video services such as SatIP, therefore allowing intelligent dynamic bandwidth allocation within the TWDM-PON.

In addition to the services described above, the majority of the functions on the OLT-side can be virtualised by using network function virtualisation (NFV) which means services can be added to the system as technology progresses. An example of this is the local caching block 70 depicted in FIG. 10, which would allow regularly used data to be intelligently cached so as to decrease latency for clients and reduce bandwidth requirements on the backhaul network. As technology for M2M communication that require ultra-low latency connections progresses, supplementary northbound applications can be added to the SDN control plane, and SDN compatible hardware (or software via NFV) can be incorporated into the access node.

Where a new service such CPRIoE and the fixed wireless access network are being transported over the TWDM-PON, wavelengths can be selected by the centralised controller because the communication for both data and control is performed using standard Ethernet packets. This means additional controllers can be introduced to the ONU's and OLT's compared to current systems, by only introducing small changes to the control systems.

As an example of implementation, the SatIP distribution over an SDN subsystem 6, has been emulated using a Mininet network emulator 74. The SDN enabled mobile front hauling subsystem, in combination with the SatIP subsystem, produce a comprehensive software/hardware platform which forms a foundation for the invention as herein described with reference to FIG. 11.

To create the SDN enabled SatIP delivery network subsystem 6, the mini net 74 was initially set up with a simple single switch 76 topology with an SDN controller attached and the virtual Mininet switch was set up with four Ethernet ports, two being internally connected to respective virtual hosts and two, 78, 79 exposed to external Ethernet ports which were then directly connected to real hardware in the form of a router 82 for providing dynamic close configuration protocol (DHCP) IP address management and the SatIP server 6″ for providing the video content to the network.

In this example, Ubuntu 16.04 was chosen as the base operating system and the SatIP client was the developer version of VLC media player compiled directly from source code. A standard OpenVswitch network controller was used for the example and the tables 1 and 2 provide the parameters that were set using the Mini net-API for emulation.

TABLE 1
Mininet Node Setup

| | | | | | SAT > IP | |
|---|---|---|---|---|---|---|
| | H1 | H2 | S1 | C0 | Server | Router |
| Real or | Emulated | Emulated | Emulated | Emulated | Real | Real |
| Emulated | | | | | | |
| Purpose | Video Client | Debugging | Switch | Controller | Video Server | DHCP |
| | | | | | | Service |
| IP Address | Static | Static | N/A | Loopback | DHCP | Static |
| | 192.168.1.2 | 192.168.1.3 | | Interface | 192.168.1.4 | 192.168.1.1 |
| | | | | 127.0.0.1 | | |

As all

TABLE 2
Mininet Link Setup

| | H1-S1 | H2-S1 | Eth1-S1 | Eth2-S1 |
|---|---|---|---|---|
| | Ethernet | Ethernet | Ethernet | Ethernet |
| Purpose | H1 | H2 | SAT > IP | DHCP |
| | connection | connection | connection | connection |
| | to Switch | to Switch | to Switch | to Switch |
| Line Rate | Unlimited | Unlimited | Unlimited | Unlimited |
| (bps) | | | | |
| Delay | 0 | 0 | 0 | 0 |
| (ms) | | | | |

Mininet virtual hosts which are run in the linux environment share the same user work space, this allows them to run instances on the same programmes at the same time and the switch S1 is emulated in the same way as virtual hosts meaning it can also run programmes like a traditional Linux user. Wireshark can therefore run on S1 with access to all Ethernet ports attached to S1 as well and the SatIP and Open Flow dissector plugins were installed so that their respective Ethernet packets could also be analysed.

To validate the set-up, Wireshark capturing was started on S1 before the hosts in Mininet were activated and while the SatIP server and DHCP server were physically disconnected from the system. Two baseline tests were then performed, a latency test and a throughput test.

To establish the initial set up time of a link in Mininet due to the controller processing time, a ping command was used to measure the latency between H1 and H2 and was repeated ten times to see the difference in latency due to the Open Flow set up time.

The Terminal output for the Ping command can be seen in FIG. 12 below, and a graphical display of these Pings can be seen in FIG. 13. The most important captured packets can be seen in FIG. 14. These results were captured using Wireshark on S1 with all of the Ethernet Interfaces

From FIG. 14, the first Ping request can be seen at No. 10. There is no reply for this Ping because there are no flow entries in S1 to allow the packet to be forwarded from H1 to H2. At No. 11 an OpenFlow flow table miss packet is sent from H1 to H2, this however is reported incorrectly and actually is being sent on the LoopBack interface from S1 to C0. At No. 12 an OpenFlow flow table modification packet is sent from C0 to S1 also using the LoopBack interface. At No. 13 the original Ping packet is now resent by S1 to H2, and at No. 14 the Ping reply is sent from H2 to H1. Again, there is no flow table entry in S1 for data being sent from H2 to H1, so at No. 15 C0 is notified on the LoopBack interface by S1 about the flow table miss. At No. 16 flow table modification is sent over the LoopBack interface from C0 to S1, and again the original Ping reply packet is resent from S1 to H1, completing the Ping.

On the second Ping from H1 to H2, only a Ping request from H1 to H2, and a Ping reply immediately after from H2 to H1, can be seen. There is no OpenFlow interaction due to the flow tables in S1 already being set up. This description is depicted in FIG. 15.

When comparing the Wireshark and terminal results, it can be seen in the terminal at the first pin, it takes 3.45 milliseconds to complete whereas in Wireshark, the difference in the ping request and reply time stamps is 1.31 ms as shown in Table 3

TABLE 3
Terminal Ping and Wireshark RTT Comparison

| | Terminal Ping Reported | Wireshark Calculated |
|---|---|---|
| Ping Number | RTT (ms) | RTT (ms) |
| 1 | 3.45 | 1.308 |
| 2 | 0.225 | 0.203 |
| 3 | 0.051 | 0.032 |
| 4 | 0.049 | 0.029 |
| 5 | 0.061 | 0.033 |
| 6 | 0.051 | 0.029 |
| 7 | 0.055 | 0.032 |
| 8 | 0.052 | 0.029 |
| 9 | 0.049 | 0.028 |
| 10 | 0.051 | 0.030 |

As can be seen, the round trip time for the ping is reduced to an average of 0.052 milliseconds at an initial OpenFlow set up according to the ping command in terminal and reduced to 0.022 milliseconds according to Wireshark. The jitter after Open Flow set up can be seen to be 0.0051 milliseconds in the terminal and 0.0029 milliseconds in Wireshark.

The difference in results when comparing the ping command in terminal and the packet analysis in Wireshark could be put down to the processing time in each virtual host, since Wireshark simply records the exact time the packet is sent and received from S1 without including a time for the virtual Ethernet links, host Ethernet port processing and host application processing because every process is sharing the same computing resources. The difference in jitter between the ping command in the terminal and the calculated jitter using Wireshark highlights the variability of processing speed in the host applications.

To establish the maximum possible bandwidth from H1 to H2 based on the current minimal set up Iperf was used to create a sender and receiver on mini net hosts. Everything running in Mininet is directly CPU based and therefore, as more is added to the system, the maximum bandwidth is reduced due to the less available CPU time for each host process.

As can be seen from FIG. 16, a maximum bandwidth of 11.7 GBPS is recorded for both upstream and downstream connections from H1 to H2 via S1.

To identify the effect of different topologies on the Ping and bandwidth, various topologies were tested as illustrated in FIG. 17. The Ping and Iperf tests previously explained were run on each topology. The results are recorded in Table 4

TABLE 4
Ping and Iperf tests for Topologies 1-4

| | | Initial | Average | Average | |
|---|---|---|---|---|---|
| | | Ping | Ping after | Jitter after | |
| | | OpenFlow | OpenFlow | OpenFlow | |
| | | Setup | Setup | Setup | Iperf |
| Topology | Hosts | Time | Complete | Complete | Bandwidth |
| Number | used | (ms) | (ms) | (ms) | (Gbps) |
| 1 | H1→H7 | 8.95 | 0.036 | 0.0043 | 15.4 |
| 2 | H1→H6 | 9.35 | 0.046 | 0.0049 | 15.3 |
| 3 | H1→H4 | 4.08 | 0.043 | 0.0059 | 21.1 |
| 4 | H1→H2 | 13.0 | 0.054 | 0.0030 | 20.3 |

In Table 4, the 3rd column displays the initial Ping result in milliseconds. This is the Ping result that also includes the OpenFlow setup time. Each topology was run for the first time with an empty flow table in S1. The 4th column displays the average Ping in milliseconds not including the first 2 Ping results. The 5th column displays the average jitter in milliseconds not including the first 2 Ping results. Finally, the 6th column displays the average Iperf bandwidth for upstream and downstream.

To get the results for Table 4, the system was running with no maximum bandwidth enforced on the system, and the delay on the links was set to 0 ms. To see the effects of a more real network with bandwidth and latency limits, the following tests had respective caps applied to links using the same topologies, 1-4 as above. The bandwidth caps were set at ×10 intervals ranging from 0.1 Mbps up to 1000 Mbps, concluding in an uncapped scenario. The hosts used for tests in each topology are the same as in Table 4. Table 5 shows the different scenarios and the respective results below.

TABLE 5
Varying Bandwidth Caps

| | Link | | Initial Ping | Average Ping | Average Jitter | |
|---|---|---|---|---|---|---|
| | Bandwidth | Latency | OpenFlow | after OpenFlow | after OpenFlow | Iperf |
| Topology | Limit | Limit | Setup | Setup Complete | Setup Complete | Bandwidth |
| Number | (Mbps) | (ms) | Time (ms) | (ms) | (ms) | (Mbps) |
| 1 | 0.1 | 0 | 11.90 | 0.059 | 0.0140 | 0.14505 |
| 1 | 1 | 0 | 8.07 | 0.055 | 0.0077 | 1.0345 |
| 1 | 10 | 0 | 9.82 | 0.066 | 0.0084 | 9.62 |
| 1 | 100 | 0 | 8.01 | 0.061 | 0.0086 | 97.65 |
| 1 | 1000 | 0 | 8.2 | 0.051 | 0.0031 | 959 |
| 1 | Unlimited | 0 | 8.0 | 0.049 | 0.0094 | 3095 |
| 2 | 0.1 | 0 | 4.27 | 0.055 | 0.0089 | 0.1175 |
| 2 | 1 | 0 | 3.29 | 0.044 | 0.0061 | 1.0745 |
| 2 | 10 | 0 | 2.82 | 0.044 | 0.0057 | 9.775 |
| 2 | 100 | 0 | 7.21 | 0.045 | 0.0067 | 97.05 |
| 2 | 1000 | 0 | 4.56 | 0.046 | 0.0023 | 957.5 |
| 2 | Unlimited | 0 | 6.62 | 0.042 | 0.0077 | 3900 |
| 3 | 0.1 | 0 | 3.77 | 0.052 | 0.0064 | 0.14375 |
| 3 | 1 | 0 | 2.87 | 0.041 | 0.0060 | 1.077 |
| 3 | 10 | 0 | 4.93 | 0.058 | 0.0050 | 9.765 |
| 3 | 100 | 0 | 2.17 | 0.056 | 0.0079 | 96.2 |
| 3 | 1000 | 0 | 4.26 | 0.041 | 0.0070 | 956 |
| 3 | Unlimited | 0 | 2.91 | 0.037 | 0.0060 | 3955 |
| 4 | 0.1 | 0 | 11.40 | 0.067 | 0.0076 | 0.1181 |
| 4 | 1 | 0 | 15.7 | 0.062 | 0.0060 | 1.0345 |
| 4 | 10 | 0 | 9.53 | 0.062 | 0.0119 | 9.68 |
| 4 | 100 | 0 | 10.2 | 0.069 | 0.0087 | 97.05 |
| 4 | 1000 | 0 | 13.3 | 0.062 | 0.0090 | 943 |
| 4 | Unlimited | 0 | 10.1 | 0.054 | 0.0057 | 12400 |

The results from Table 5 are represented in FIG. 18. FIG. 18(a) depicts the Initial Ping vs. the Bandwidth Limit. FIG. 18(b) depicts the Average Ping after OpenFlow setup vs. the Bandwidth Limit. FIG. 18(c) depicts the average Jitter after OpenFlow setup between the test hosts vs. the Bandwidth Limit. FIG. 18(d) depicts the Iperf Bandwidth between the test hosts vs. the Bandwidth Limit.

These results show that the OpenFlow setup time, average ping, and average jitter are generally unaffected by the bandwidth limits applied to the network links. However, the Iperf bandwidth behaves as expected by closely following the bandwidth limits set in each topology.

A similar test to determine the effects of varying latency was also performed with latencies of 0, 1, 5, 10, 50 and 100 ms for all respective topologies, and with all bandwidths unrestricted. The results for this test can be seen in Table 6.

TABLE 6
Varying Latency Limits

| | Link | | Initial Ping | Average Ping | Average Jitter | |
|---|---|---|---|---|---|---|
| | Bandwidth | Latency | OpenFlow | after OpenFlow | after OpenFlow | Iperf |
| Topology | Limit | Limit | Setup Time | Setup Complete | Setup Complete | Bandwidth |
| Number | (Mbps) | (ms) | (ms) | (ms) | (ms) | (Mbps) |
| 1 | Unlimited | 0 | 6.96 | 0.049 | 0.01 | 3090 |
| 1 | Unlimited | 1 | 21.1 | 8.058 | 0.01 | 131 |
| 1 | Unlimited | 5 | 85.3 | 40 | 0 | 1570 |
| 1 | Unlimited | 10 | 165 | 80 | 0 | 34.3 |
| 1 | Unlimited | 50 | 805 | 400 | 0 | 73.6 |
| 1 | Unlimited | 100 | 1604 | 800 | 0 | 5.79 |
| 2 | Unlimited | 0 | 8.92 | 0.043 | 0 | 4050 |
| 2 | Unlimited | 1 | 15.1 | 6.050 | 0.01 | 49.2 |
| 2 | Unlimited | 5 | 64.2 | 30 | 0 | 2120 |
| 2 | Unlimited | 10 | 123 | 60 | 0 | 957 |
| 2 | Unlimited | 50 | 604 | 300 | 0 | 127 |
| 2 | Unlimited | 100 | 1202 | 600 | 0 | 21.5 |
| 3 | Unlimited | 0 | 4.26 | 0.038 | 0.0034 | 6690 |
| 3 | Unlimited | 1 | 10.2 | 4.037 | 0.0043 | 430 |
| 3 | Unlimited | 5 | 41.5 | 20 | 0 | 3230 |
| 3 | Unlimited | 10 | 81.4 | 40 | 0 | 1260 |
| 3 | Unlimited | 50 | 401 | 200 | 0 | 235 |
| 3 | Unlimited | 100 | 803 | 400 | 0 | 73.6 |
| 4 | Unlimited | 0 | 9.64 | 0.047 | 0.0064 | 7420 |
| 4 | Unlimited | 1 | 26.3 | 10 | 0 | 6320 |
| 4 | Unlimited | 5 | 105 | 50 | 0 | 1240 |
| 4 | Unlimited | 10 | 205 | 100 | 0 | 568 |
| 4 | Unlimited | 50 | 1007 | 500 | 0 | 36.2 |
| 4 | Unlimited | 100 | 2007 | 1000 | 0 | 1.73 |

The results from Table 6 are represented in FIG. 19. FIG. 19(a) depicts the Initial Ping vs. the applied Latency. FIG. 19(b) depicts the Average Ping after OpenFlow setup vs. the applied Latency. FIG. 19(c) depicts the average Jitter after OpenFlow setup between the test hosts vs. the applied Latency. FIG. 19(d) depicts the Iperf Bandwidth between the test hosts vs. the applied Latency.

As can be seen from FIG. 19, the initial Ping and average Ping scale according to the number of hops between the hosts used in the topology. For example, in topology 4 there are 5 switches between the 2 hosts used for testing, and we can see the average latency after OpenFlow setup is 1000 ms when 100 ms latency is applied. This is because the Ping packet has to transverse 5 switches in both directions, meaning 10 hops overall. These 10 hops all have 100 ms latency, and therefore the overall latency is 10×100 ms=1000 ms. Additionally, the Iperf bandwidth between the 2 hosts can be seen to diminish as the latency is increased. This is due to the TDP throttling in high latency links.

The next important statistic in the Mininet network is the CPU time given to each virtual host. The CPU time is the percentage of overall processing that a host has access to. If 10% is selected for H1, then H1 will only be provisioned 10% of the total CPU time by the operating system (OS). This is useful for making sure that virtual hosts do not ‘hog’ the CPU time, and therefore decrease the CPU time for other applications in the OS.

To check the effect of CPU limiting on Mininet hosts, the CPU percentage allocation was changed from 1% to 99% in 1% increments. Topology number 1 was chosen from the previous tests. FIG. 20 provides the Iperf bandwidth recorded for tests from 1% to 60% using a set latency of 0 ms, and no bandwidth restriction per link.

As can be seen by FIG. 20, the Iperf bandwidth between the hosts increases until the 50% mark is reached. At this point, each host is provisioned for example 55%, but cannot realistically exceed 50%, because more than 100% total CPU usage is not possible.

For real time video transmission, after the Mininet network had been characterised, a real SAT>IP stream was set up using a Mininet host. To do this, 2 virtual Ethernet ports from a virtual switch were exposed to the real world. One port was connected to the SAT>IP server, and the other to a DHCP server for IP address provisioning. The video client in this scenario was a version of VLC with SAT>IP capability, running on virtual Mininet Host 2. Three tests were then performed.

Firstly, Wireshark was used to validate the SAT>IP stream flowing through Mininet. FIG. 21 shows the Wireshark capture for the SAT>IP stream. FIG. 22 depicts the networking timing diagram for this scenario.

Secondly, the latency requirements for SAT>IP streaming were determined. To do this, the latency of the link from S1 to H1 was increased from 0 ms to 2000 ms in 100 ms steps. The SAT>IP video was requested in each case and left to play for 30 seconds, the result of the video playback was then determined by looking at the VLC debugging output in the terminal window. One of the debugging output features in VLC informs the user of dropped frames. When dropped frames were indicated by the debugger, and when the video stream was visibly distorted, the result was marked as ‘Break Up’. Table 7 contains the results from this test.

TABLE 7
Varying the latency for a real SAT > IP stream

| Latency (ms) | Video Working? |
|---|---|
| 0 | Yes |
| 100 | Yes |
| 200 | Yes |
| 300 | Yes |
| 400 | Yes |
| 500 | Yes |
| 600 | Yes |
| 700 | Yes |
| 800 | Yes |
| 900 | Yes |
| 1000 | Yes |
| 1100 | Yes |
| 1150 | Yes |
| 1200 | Break Up |
| 1300 | Break Up |
| 1400 | Break Up |
| 1500 | Break Up |

Once video distortion was seen at 1200 ms latency, further testing concluded that approximately 1150 ms was the tipping point for video break up and no video break up. FIG. 23 shows the difference between a good video signal, and a poor video signal.

Thirdly, the bandwidth requirements for SAT>IP streaming were determined. To do this, the maximum bandwidth on the link from S1 to H1 was increased from 1 Mbps to 10 Mbps in 1 Mbps steps. The SAT>IP video was requested in each case, the result of the “Video Working?” test was then recorded. Table 8 contains the results from this test.

TABLE 8
Varying the maximum bandwidth
for a real SAT > IP stream

| Max Bandwidth (Mbps) | Video Working? |
|---|---|
| 1 | No |
| 2 | No |
| 3 | No |
| 4 | No |
| 5 | No |
| 5.5 | No |
| 5.6 | No |
| 5.7 | No |
| 5.8 | No |
| 5.9 | No |
| 6 | No |
| 6.1 | Yes |
| 7 | Yes |

TABLE 9
CPU Percentage Variation for VLC Client on Host

| CPU Percentage (%) | Video Working? |
|---|---|
| 1 | No |
| 10 | No |
| 20 | No |
| 30 | No |
| 40 | No |
| 50 | No |
| 55 | Mostly |
| 60 | Yes |
| 70 | Yes |
| 80 | Yes |
| 90 | Yes |
| 100 | Yes |

As can be seen from Table 8, a bandwidth of 6.1 Mbps is required to stream High Definition (HD) video from the SAT>IP server to the Mininet host's VLC client.

Finally, the CPU percentage required for SAT>IP streaming by a Mininet host was then determined. To do this the CPU percentage per host was changed from 1 to 100%. The SAT>IP video was requested in each case, the result of the “Video Working?” test was then recorded. Table 9 contains the results from this test. It can be seen from Table 9, a VLC client requires approximately 60% of CPU time on the particular hardware being used for this test.

FIG. 24 shows a test system which can be utilised in accordance with the invention

Thus, as the demand from users over the next few years is expected to increase dramatically due to new technologies, becoming ever more readily available and commercially deployed, the demands on network systems will increase. Furthermore, M2M and HD video have significantly different requirements compared to previously used services as M2M communication requires very low latency connections but doesn't require large data bandwidths whilst, conversely, HD video requires large data bandwidths but doesn't require low latency connections. These differences and different requirements, in conventional systems cannot be used in the current form. The proposed architecture in relation to the current invention, allows SDN enabled TWDM-PON to allow the fixed wireless access network, cellular network and legacy PON to coexist in the same infrastructure and, using the SDN platform on the central side of the access network SatIP and intelligent caching video offload is capable of removing loads from the backhaul and CDN network and thereby increasing the QoE to video users and other high bandwidth applications. Additionally, the use of SatIP QoE feedback allows intelligent changes to be made to the network using SDN to help improve the QoE for users.

The architecture of the invention also allows SDN enabled novel techniques such as CoMP, intelligent caching, QoE assurance, and CDN ISP collaboration to be developed and installed.

Finally, there is an increasing growth in a new type of service which relates to machine to machine communication which is a service which is growing quickly as the number of devices which are both autonomous and cloud oriented increases. Thus, everyday appliances such as fridges and washing machines are increasingly connected to the cloud and thereby offering intelligence options to users which were not previously possible such as, for example, to allow a device to autonomously order in new components when required, order specific foodstuffs for their owners when stocks of that particular foodstuff is running low and so on. Furthermore, higher risk applications of M2M such as autonomous vehicles are increasingly being researched and developed and it is likely that these will slowly be introduced to everyday life in the near future.

The ability in accordance with the present invention to allow a data distribution network to be adapted to react to changing requirements and to allow, if required, the distribution of data at least partially in an optical format means that an efficiently operated data distribution network can be provided for significantly longer periods of time thereby reducing the need for removal and replacement of distribution networks as conventionally occurs in order to meet changes in demand.

### KEY TO ACRONYMS AND ABBREVIATIONS USED IN THIS APPLICATION

3D Third Dimension

3GPP Third Generation Partnership Project

5G Fifth Generation

ADC Analogue to Digital Conversion

API Application Programming Interface

BBU Baseband Unit

BS Big Switch

BRAS Broadband Remote Access Server

CAGR Compound Annual Growth Rate

CDN Content Distribution Network

CPRIoE Common Public Radio Interface over Ethernet

CRAN Centralised Radio Access Network

DAS Distributed Antenna System

DHCP Dynamic Host Configuration Protocol

DSL Digital Subscriber Line

DSP Digital Signal Processing

DNS Domain Name System

DVB Digital Video Broadcast

DVB-T2 Digital Video Broadcast-Terrestrial Version 2

EPC Evolved Packet Core

FEC Forward Error Correction

FTTH Fibre to the Home

GPON Gigabit Passive Optical Network

HD High Definition

HTB Hierarchical Token Bucket

IMDD Intensity-Modulation Direct Detection

IMT International Mobile Telecommunications

IOs Input and Outputs

IoT Internet of Things

IP Internet Protocol

IQ In-phase Quadrature-phase

ISP Internet Service Provider

JWBLB Joint Wireless and Backhaul Load Balancing

LTE Long Term Evolution

M2M Machine to Machine

NFV Network Function Virtualisation

OAI Open Air Interface

OAM Operations, Administration and Maintenance

OFDM Orthogonal Frequency Division Multiplexing

OLT Optical Line Terminal

OMCI ONU Management and Control Interface

ONU Optical Network Unit

OOK On-Off Keying

OS Operating System

OSU Optical Service Unit

OTT Over the Top

PON Passive Optical Network

QoE Quality of Experience

QoS Quality of Service

RRH Remote Radio Head

RRU Remote Radio Unit

RTP Real Time Protocol

RTSP Real Time Streaming Protocol

RTT Round Trip Time

SDN Software Defined Network(ing)

SDR Software Defined Radio

SON Self Optimisation Network

TCP Transfer Control Protocol

TDM Time Division Multiplexing

TSNTG Time Sensitive Networking Task Group

TWDM-PON Time-Wavelength Division Multiplexing-Passive Optical Network

UDP User Datagram Protocol

URL Uniform Resource Locator

USS User Space Switch

VM Virtual Machine

VLCW Virtual Link with Constant Weights

VLVW Virtual Link with Variable Weights

WiFi Wireless Fidelity

WDM Wavelength Division Multiplexing

1. A system for the provision of data to a number of devices simultaneously, said system comprising:
at least one data source from which data broadcast from a remote location is accessible;
a data distribution network to which data from the at least one data source is transferred and made available to a plurality of devices connected to the data distribution network; and
a control means in the form of a software defined networking enabled orchestration function.

2. A system according to claim 1 wherein the orchestration function adapts the system to absorb an increase in demand in relation to additional devices added to an optical data distribution network.

3. A system according to claim 1, wherein the orchestration function adapts the system to absorb an increase in demand in relation to an increase in data provided to an optical data distribution network.

4. A system according to claim 1 wherein the orchestration function enables a service provision to be at least maintained while increasing at least one of device access and data provision.

5. A system according to claim 4 wherein the orchestration function enables any, or any combination of members selected from the group consisting of: re-configurability, the meeting of latency requirements, adaptive network functionality and the quality of user experience to be adapted to match an increase in said plurality of devices.

6. A system according to claim 1 wherein the orchestration function consolidates mobile front hauling with emerging internet protocol based radio streaming applications.

7. A system according to claim 1 wherein the orchestration function allows provision of any, or any combination of members from the group consisting of: network function decentralisation, support for mobile front hauling using common public radio interface, common public radio interface over ethernet services, optical line terminal-side intelligent caching using local network function virtualization, quality of experience assurance via content distribution network internet service provider collaboration and local video streaming replacement services by using optical line terminal side satellite internet protocol servers.

8. A system according to claim 1 wherein the orchestration function is centralised with respect to the system and is controlled and adapted via a system administration facility.

9. A system according to claim 1 wherein at least one application programming interfaces is used to control network hardware.

10. A system according to claim 1 wherein the at least one data source includes data obtained via any or any combination of members selected from the group consisting of: internet protocol, digital broadcast systems and satellite internet protocol.

11. A system according to claim 10 wherein integration of the satellite internet protocol data reduces back haul network congestion to allow users to stream multi-media live feeds directly from satellite internet protocol servers.

12. A system according to claim 1 wherein connectivity to at least one of cellular, femtocell and wireless fidelity communication technologies is achieved using time-wavelength division multiplexing-passive optical network hauling.

13. A system according to claim 12 wherein said connectivity is achieved in close proximity to intelligence access nodes of a premises in which the system is implemented via the orchestration function.

14. A system according to claim 1 wherein the data distribution network is split into slices or sectors and said slices or sectors are controlled independently.

15. A system according to claim 14 wherein the slices or sectors are controlled by respective allocated network operators within network operating parameters so as to allow each of the operators to selectively adapt operation and control of the slice or sector for which they are responsible.

16. A system according to claim 15 wherein adaptation includes introducing at least one of low latency and high bandwidth features to operation of a particular slice or sector.

17. Apparatus for the distribution of video and/or audio data, said apparatus comprising:
a data receiving apparatus including at least one satellite antenna and low-noise block vi which data is received from one or more remote locations,
a plurality of user devices capable of receiving a portion of said data and processing the data to generate video and/or audio on a display screen and/or speakers provided on or in connection with said plurality of user devices,
a data distribution network to which the plurality of user devices can be selectively connected and
a software defined network enabled orchestration function to allow adaptation of operation of performance of the data distribution network to be controlled with respect to at least one of user device demands, data capacity demands and control of whole or slices or sectors of the network to be achieved.

18. Apparatus according to claim 17 wherein the data is transferred in the data distribution network at least for a portion of the data in an optical format using fibre optic cabling.

19. Apparatus according to claim 18 wherein laser transmitters and/or receivers are provided at interfaces between the data distribution network fibre optic cabling and a hardware apparatus which require the data to be provided in an alternative format for processing and/or onward transmission and/or which have received the data in another format.

20. A method for provision of data for video and/or audio to a number of devices simultaneously, said method comprising:
providing at least one data source from which data broadcast from a remote location is accessible;
transferring data from the at least one data source to a data distribution network and making the data available to a plurality of devices connected to the data distribution network; and
connecting the data distribution network to a control means in a form of a software defined networking enabled orchestration function and adapting said data distribution network via said orchestration function with respect to at least one capacity for data transfer, number of devices connected to the data distribution network and control of the data distribution network as a whole or in slices or sectors independently.
